(19) United States
(12) Patent Application Publication
(10) Pub. No.: US 2004/0099766 A1
(43) Pub. Date: May 27, 2004

(54) Aircraft passenger seat with seat back control array

(76) Inventor: John H. Pratt JR., Bethlehem, CT (US)

Correspondence Address: W. Thad Adams, III, ADAMS, SCHWARTZ & EVANS, P.A., 2180 Two Wachovia Center, Charlotte, NC, 28282, US

(21) Appl. No.: 10/305,846

(22) Filed: Nov. 27, 2002

(51) Int. Cl. B64D 11/06; B64D 13/00

(52) U.S. Cl. 244/118.6

(57) ABSTRACT

A passenger seat of the type having passenger-controllable functions, and including a seat base, a seat frame mounted on the seat base, and a seat back and seat bottom carried by the seat frame. The passenger seat includes at least one passenger-operable function. A function control communication system is carried by the passenger seat for operative communication with a rearward-facing seat back panel of a second passenger seat positioned immediately forward of the passenger seat. Function controls carried on the rearward-facing seat back panel for operative connection with the function control communication system, that may be wireless and remotely or manually operable, for permitting a passenger seated in the passenger seat to control functions of the seat by utilization of the function controls on the seat back panel of the second passenger seat immediately forward of the passenger.

### TECHNICAL FIELD AND BACKGROUND OF THE INVENTION

This invention relates to an aircraft passenger seat. Aircraft passenger seats are typically constructed from modular components, the size, weight and construction of which are dictated by many considerations, including fuselage dimensions, aesthetic and safety considerations. Many of these requirements are imposed by law or regulation. The lower seat chassis is constructed of leg modules, while the upper seat is constructed of section assembly modules. Aircraft passenger seats of all classes are required to function within very strictly confined space. Many convenience features have been added to aircraft passenger seats over the years to provide access to and control of audio/video systems, to permit laptop computers to be powered off of the aircraft power supply, to permit telephone communication from seat-located telephones, and to permit a greater degree of seat adjustment. All of these features require some type of passenger-operated controls. Typically, these controls are mounted either on the arm rest or on the service panel directly above the seat. In many cases the arm rest-mounted controls can only be reached by bodily contortions and, in any event, are not clearly visible because they are hidden from direct view. Particularly when the cabin lights are dimmed, the arm rest-mounted controls must be operated more by feel than by sight. In many instances, the service panel-mounted controls cannot be reached by short passengers without standing up.

Manufacturers of aircraft are constantly refining seat designs to achieve more comfort and utility within carrier-imposed restraints on cost, weight, maintenance down-time, and safety. Many conventional aircraft seats are designed with a stationary seat bottom to which is attached a reclinable seat back. When the seat back is reclined, it encroaches on the space of the aft-seated passenger. The requirement that the seat back be moveable has required prior art seats to, for example, have meal trays mounted on a seat beam or other stationary underseat component so that the tray does not move towards or away from the user when the forward seat back is moved. Insofar as is known, the seat back of a aircraft passenger seat has not previously been used as a platform for mounting the seat controls of a passenger seated behind the seat.

### SUMMARY OF THE INVENTION

Therefore, it is an object of the invention to provide a passenger seat having its controls mounted on the back of another forwardly-positioned seat.

It is another object of the invention to provide a passenger seat having a stationary back on which seat controls are mounted for controlling another seat behind the stationary back.

It is another object of the invention to provide a passenger seat wherein a passenger seated in a particular seat is able to control his seat by manipulating controls positioned on the back of another seat directly forward of the passenger.

It is another object of the invention to provide a passenger seat wherein the seat controls are mounted on a support, for example, a seat back or bulkhead, immediately forward of the seat and within reach of a passenger seated in the seat.

These and other objects of the present invention are achieved in the preferred embodiments disclosed below by providing a passenger seat of the type having passenger-controllable functions, comprising a seat base, a seat frame mounted on the seat base, and a seat back and seat bottom carried by the seat frame. The passenger seat includes at least one passenger-operable function. Function control communication means are carried by the passenger seat for operative communication with a rearward-facing seat back panel of a second passenger seat positioned immediately forward of the passenger seat. Manual function controls carried on the rearward-facing seat back panel for operative connection with the function control communication means for permitting a passenger seated in the passenger seat to control functions of the seat by manual utilization of the manual function controls on the seat back panel of the second passenger seat immediately forward of the passenger.

According to one preferred embodiment of the invention, the passenger-operable function is chosen from the group consisting of audio/video controls, a seat back position control, a seat bottom position control, a flight attendant call control, reading light control and ventilation control.

According to another preferred embodiment of the invention, a video display is mounted in the rear-facing seat back panel of the second passenger seat for viewing by the passenger in the passenger seat.

According to yet another preferred embodiment of the invention, a meal tray is carried by the rear-facing seat back panel of the second passenger seat for movement by the passenger in the passenger seat between an upright stowed position against the seat back panel and a lowered use position over the lap and knees of the passenger.

According to yet another preferred embodiment of the invention, a video display is mounted in the rear-facing seat back panel of the second passenger seat for viewing by the passenger in the passenger seat, and a meal tray is carried by the rear-facing seat back panel of the second passenger seat for movement by the passenger in the passenger seat between an upright stowed position against the seat back panel and a lowered use position over the lap and knees of the passenger.

According to yet another preferred embodiment of the invention, the manual function controls are positioned around the video display monitor.

An embodiment of the method of controlling a seat according to the invention comprises the steps of providing a first passenger seat, including a seat base, a seat frame mounted on the seat base, and a seat back and seat bottom carried by the seat frame. The passenger seat includes at least one passenger-operable function. Function control communication means are provided on the first passenger seat. Manual function controls are provided on a rearward-facing seat back panel of a second seat positioned immediately forward of the first seat for operative connection with the function control communication means for permitting a passenger seated in the first passenger seat to control functions of the first seat by manual utilization of the manual function controls on the seat back panel of the second passenger seat immediately forward of the passenger.

According to yet another preferred embodiment of the invention, the step of providing function control communication means comprises selecting the passenger-operable function from the group consisting of audio/video controls, a seat back position control, a seat bottom position control, a flight attendant call control, reading light control and ventilation control.

According to yet another preferred embodiment of the invention, the method includes the step of mounting a video display in the rear-facing seat back panel of the second passenger seat for viewing by the passenger in the first passenger seat.

According to yet another preferred embodiment of the invention, the method includes the step of mounting a meal tray on the rear-facing seat back panel of the second passenger seat for movement by the passenger in the first passenger seat between an upright stowed position against the seat back panel and a lowered use position over the lap and knees of the passenger.

According to yet another preferred embodiment of the invention, the method includes the steps of mounting a video display in the rear-facing seat back panel of the second passenger seat for viewing by the passenger in the first passenger seat, and mounting a meal tray on the rear-facing seat back panel of the second passenger seat for movement by the passenger in the first passenger seat between an upright stowed position against the seat back panel and a lowered use position over the lap and knees of the passenger.

According to yet another preferred embodiment of the invention, the method includes the step of positioning the manual function controls are around the video display monitor.

According to yet another preferred embodiment of the invention, the controls on the seat back include a detector for receiving wireless control signals from a hand-held remote controller.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a three-seat assembly according to a preferred embodiment of the invention;

FIG. 2 is a side elevation of the seat assembly shown in FIG. 1, with interior components shown;

FIG. 3 is a side elevation similar to FIG. 2 with the leg rest extended;

FIG. 4 is a perspective view of a unitary seating element according to a preferred embodiment of the invention;

FIG. 5 is a right side elevation of an alternative embodiment of the present invention;

FIG. 6 is a rear perspective view showing the seat arm rest and its relationship to knee room available to an aft-seated passenger, in partial assembly with seating elements removed for clarity;

FIG. 7 is a elevation of the rear of a seat back that may be used on a seat according the present invention;

FIG. 8 is a left side elevation of the seat shown in FIG. 5;

FIG. 9 is a rear view of a three-seat assembly according to one embodiment of the invention; and

FIG. 10 is a rear view of a three-seat assembly according to one embodiment of the invention.

### DESCRIPTION OF THE PREFERRED EMBODIMENT AND BEST MODE

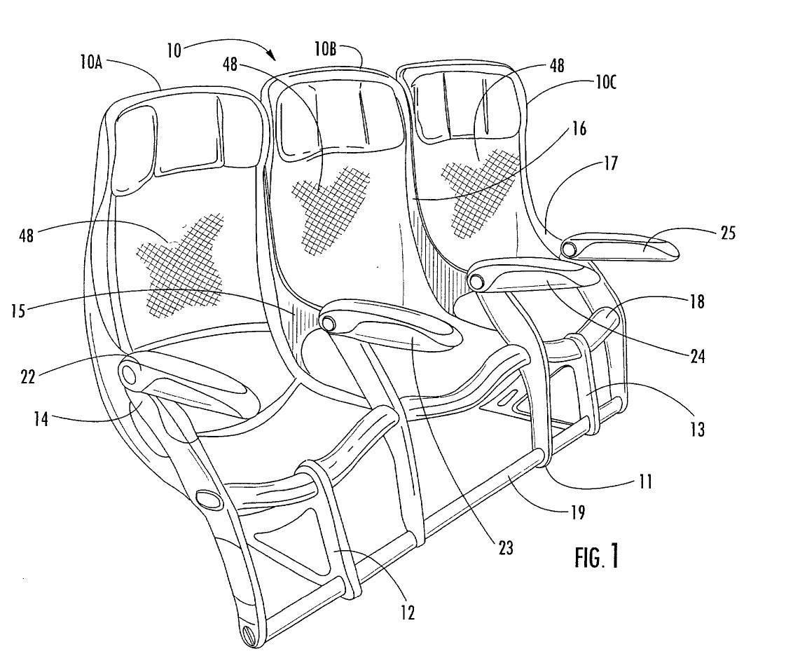

Referring now specifically to the drawings, a three-seat seat set according to the present invention is illustrated in FIG. 1 and shown generally at reference numeral 10 and comprises individual joined seats 10A, 10B, 10C that are movable from an upright to a recline position without encroaching on an aft-seated passenger. This type of seating is conventionally referred to as “coach” or “main cabin” seating as distinct from larger and more complex first class or business class seating. As will be seen below, the features of this invention are also applicable to first and business class seating. The seat set 10 includes a seat base 11. The seat base 11 includes a pair of leg assemblies 12 and 13 for being attached to a supporting surface by means of conventional track fittings such as disclosed in applicant's U.S. Pat. Nos. 4,776,533; 5,169,091 and 5,871318. Four seat frames 14, 15, 16 and 17 are connected by single laterally-extending beam 18. A baggage guard rail 19 prevents baggage stowed under the seats 10A, 10B, 10C from sliding forward into the leg area of the passengers.

The beam 18 represents a radical departure from conventional seat design, where a pair of parallel fore-and aft beams provide support to the entire seat structure. The beam 18 is oval in cross-section and downwardly curved laterally across the front of each of the seats 10A, 10B, 10C. This combination of the oval cross-section and the curve provides sufficient strength to support the entire on the leg assemblies 12 and 13, thus eliminating the need for a second beam.

Each seat 10A, 10B, 10C thus includes a pair of the shared, laterally spaced-apart seat frames 14, 15, 16 and 17, each of which has a curved shape generally corresponding to the profile of an anatomically-appropriate generally horizontal seat bottom and generally vertical seat back, and includes an extension to the floor. Arm rests 22, 23, 24 and 25 are pivotally-mounted on respective seat frames 14, 15, 16 and 17.

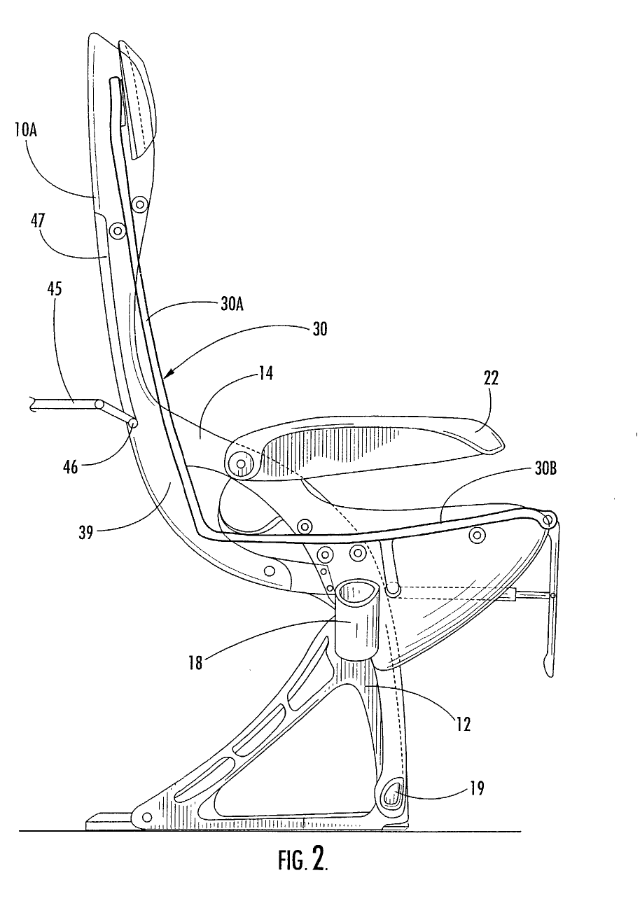

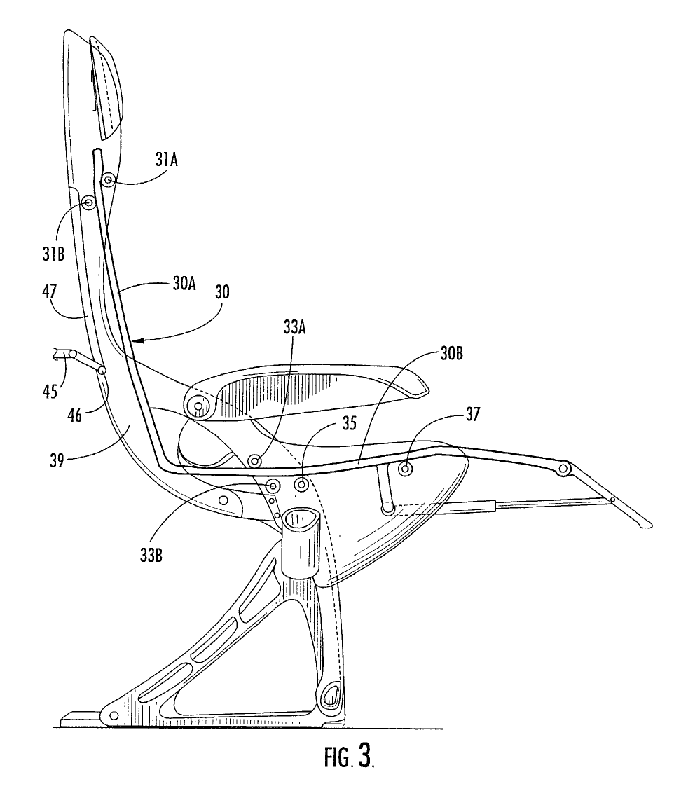

Referring now to FIGS. 2, 3 and 4, seat 10A, exemplary of each of the seats 10A,10B, 10C, has a curved, semi-rigid diaphragm support 30 carried by seat frames 14, 15 in alignment with the curved shape of the seat frames 14, 15 and mounted for movement relative to the seat frames 14,15 between a first, upright position, FIG. 2, and a second, reclined position, FIG. 3. The diaphragm support 30 is preferably made of a controlled flex material, such as a laminated composite carbon fiber resin. This material is well-known as a lightweight, durable and relatively inert material particularly suitable for aircraft use. Other materials having similar characteristics may also be used, including various polymers, particularly including nonflammable polymers. The support 30 is molded into the desired shape using conventional carbon fiber molding and fabrication techniques, and forms a seat back 30A and a seat bottom 30B.

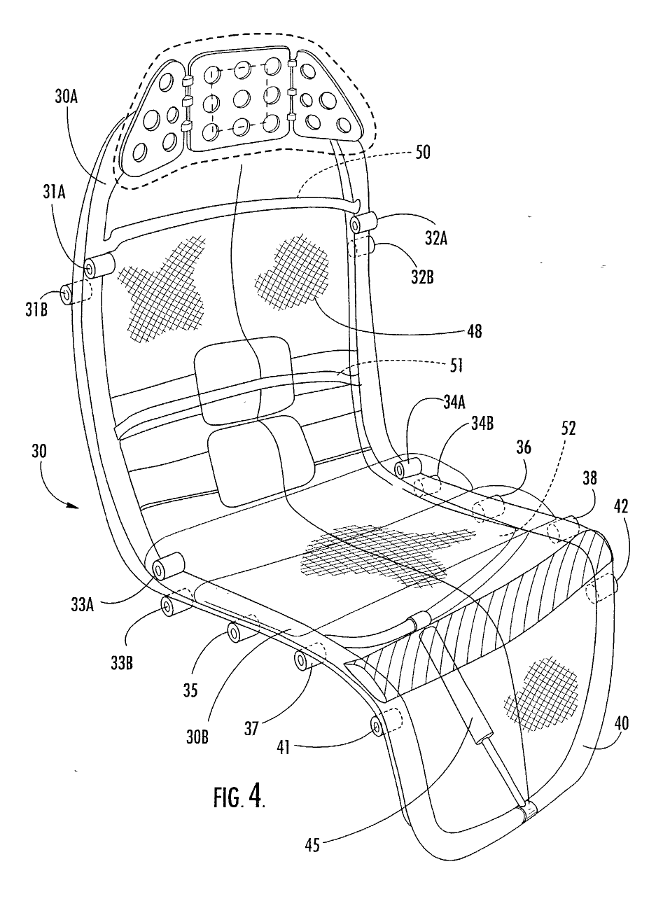

The diaphragm support 30 is mounted on the seat frames 14, 15 by means of sets of cooperating rollers between which the diaphragm support 30 is captured. As is best shown in FIG. 4, rollers 31A,31B and 32A,32B and 33A,33B and 34A,34B are carried by the seat frames 14, 15 and engage the front and back sides of the diaphragm support 30 to provide roller surfaces against which the diaphragm support 30 rides. The forward portion of the seat bottom is supported by rollers 35, 36 and 37, 38, also carried by the seat frames 14,15. The foot rest 40 is pivotally-mounted on pivot pins 41, 42 for movement between a retracted position, FIGS. 2 and 4, and an extended position, FIG. 3. The foot rest 40 is extended and retracted by a conventional gas strut.

The diaphragm support 30 is covered by a diaphragm 48 in the form of a fabric seat suspension material such as a material made by DuPont and sold under the trademark Dymetrol 200, or a unidirectional fabric sold under the trademark Crystal Flex, or any other suitable fabric. The material 48 is stretched onto the diaphragm support 30 under tension and provides a seating surface.

As is shown by comparing FIGS. 2 and 3, passenger recline is achieved by translation of the diaphragm support 30 downwardly relative to the seat frames 14, 15. The rollers 31A, 31B, 32A, 32B, 33A, 33B, 34A, 34B, 35, 36, 37 and 38 permit the diaphragm support 30 to translate within a narrow range of motion. The weight of the passenger is sufficient to cause the diaphragm support 30 to slide downwardly. The diaphragm support 30 is locked into position as desired by a piston and cylinder assembly, not shown, positioned under the seat 10A, such as a “Mechlok” linear locking device manufactured by P.L. Porter Controls, Inc. Leg pressure is used to raise and lock the seat in a desired position.

The seats 10A, 10B, 10C are trimmed with a protective and decorative shell 39, within which the structural components and operative elements of the seat are enclosed and protected. A meal tray 45 is mounted on a pivot 46 for movement between a horizontal use position and a vertical stowed position in a recess 47 in the shell 39.

The above-described seat design has the effect of causing the passenger to recline by rotating the passenger about a pivot point in the area of the hips. The passenger's back moves downwardly and the legs move upwardly, maintaining the same relative body position. This provides a more comfortable recline position without the tendency of the passenger to merely slide forward on the seat bottom when the seat back is reclined.

Curved stretchers 50, 51, 52 extend between opposite sides of the diaphragm support 30 and maintain the width of the diaphragm 30 and thus the tension on the diaphragm 48.

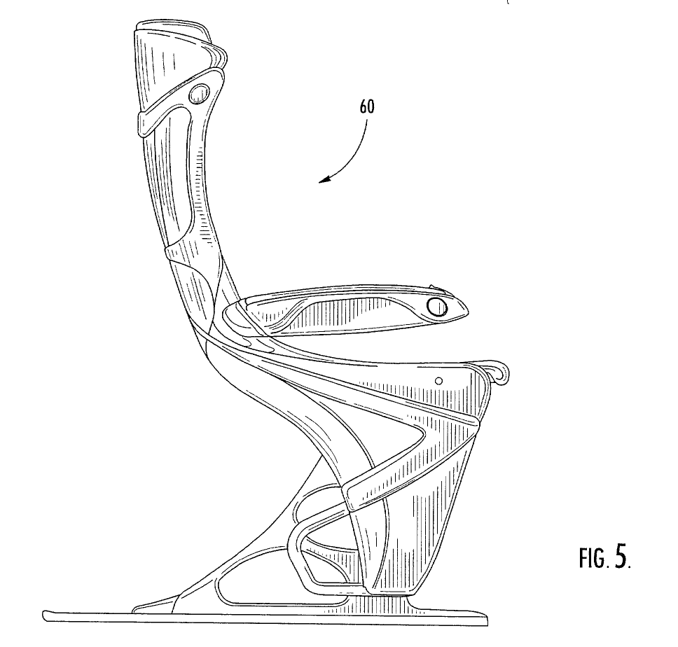

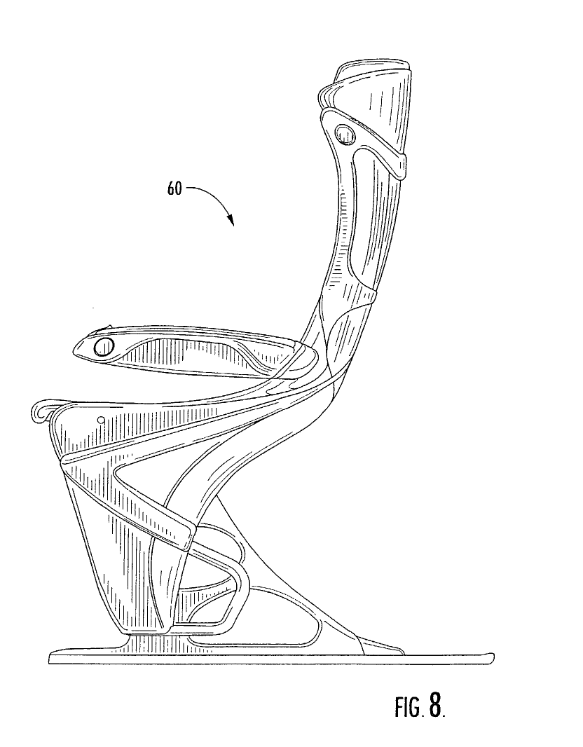

A alternative embodiment of the seat 10A is shown in FIGS. 5 and 8 at reference number 60.

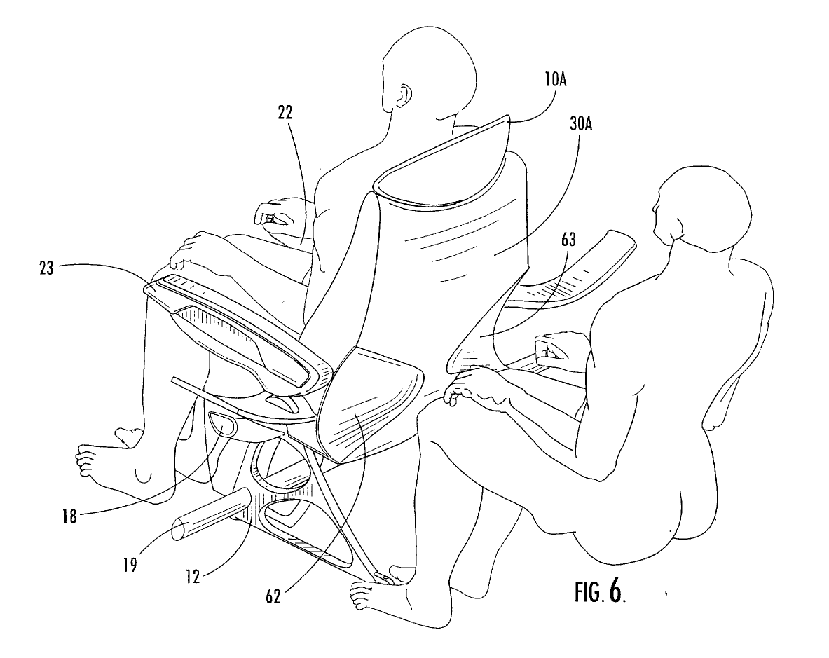

Referring now to FIG. 6, the view demonstrates features that result from moving the arm rest pivot forwardly and the absence of the aft beam present in prior art seats. As is shown, the pivot of the arm rest 23 is now at a point directly under the elbow of the passenger, and does not extend rearwardly into the plane of the seat back. Without the requirement to provide space between adjacent seat backs for the stowed arm rest to reside, the seat back can be made wider, and the area where the arm rest pivot would normally be positioned can be made available for other uses. As shown in FIG. 6, the seat back 30A includes two concave, inwardly-dished areas 62, 63 that reside forwardly of the knee areas of the aft-seated passenger. These areas provide greater knee clearance for all passengers and particularly for taller passengers whose knees are typically within several inches of the seat back, it not actually touching. This, in combination with the above-described seat back design features that avoid aft movement of the seat back 30A when the passenger reclines the seat, provides an ergonomic design that provides greater comfort for both the forward and the aft-seated passengers.

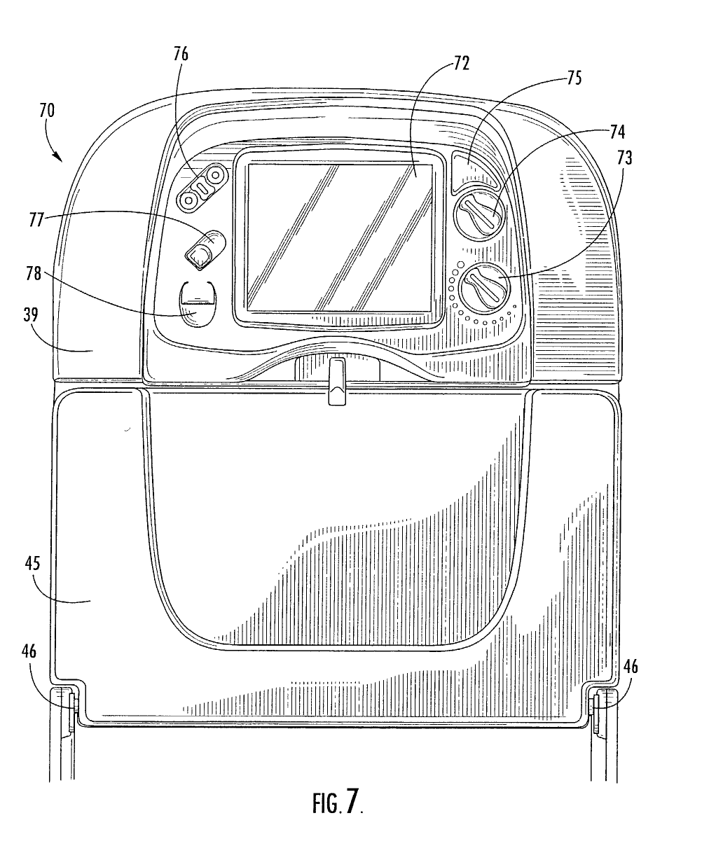

Referring now to FIG. 7, a view of the rear side of a seat back 70 according to one embodiment of the invention is shown. In this particular embodiment, the rear of the seat above the meal tray 45 is provided with a audio/video system that includes a video screen 72. In addition, all of the audio/video controls, the flight attendant call button, reading light, and seat adjustment controls are positioned on the seat back 70 around the video screen 72 in a desired arrangement at reference numerals 73-78. This position is much more accessible than controls that are now often positioned on the inside face of the arm rest where they are hard to see and operate.

Of course, any desired combination of controls can be positioned as shown, with other controls in their conventional positions. Control cables are routed from seat 10A and overhead-positioned features such as lighting to a forward-positioned seat back by a wiring chase positioned on the deck of the aircraft, through the bulkheads. Certain functions may be controlled by a wireless system. Similarly, the passenger can be provided with a hand-held remote controller by which the functions on the seat back are controlled. The remote controller may be infrared or other known wireless system. In such a system, the manually-controlled features may be eliminated so that only the remote controller will control the seat functions, or the remote control feature may be optional. The remote controller may be stored in a pocket in the seat back, arm rest or other suitable location.

This design illustrates further advantages obtained by maintaining the seat back in a stationary position. The video screen 72 does not move and thus does not require a mechanism to pivot the screen 72 to compensate for movement of the seat back. All of the controls on the seat back 39 are easy to see and reach by the passenger.

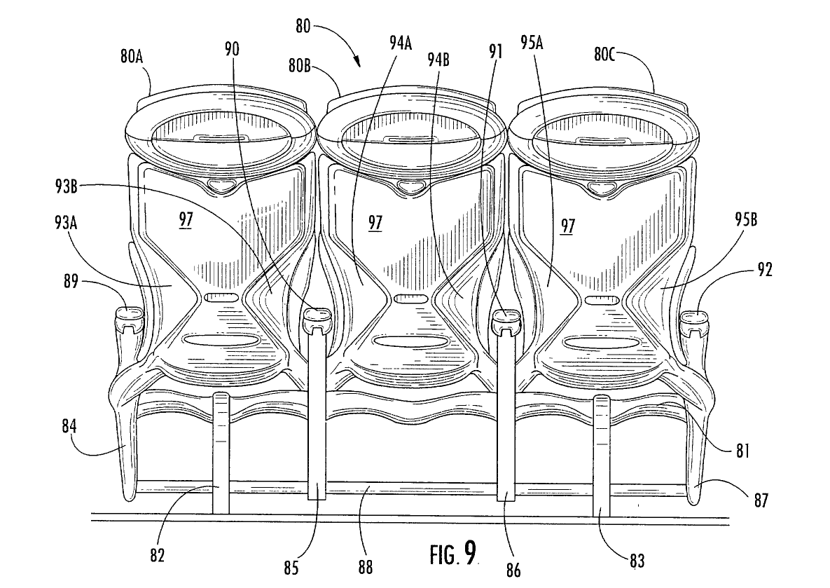

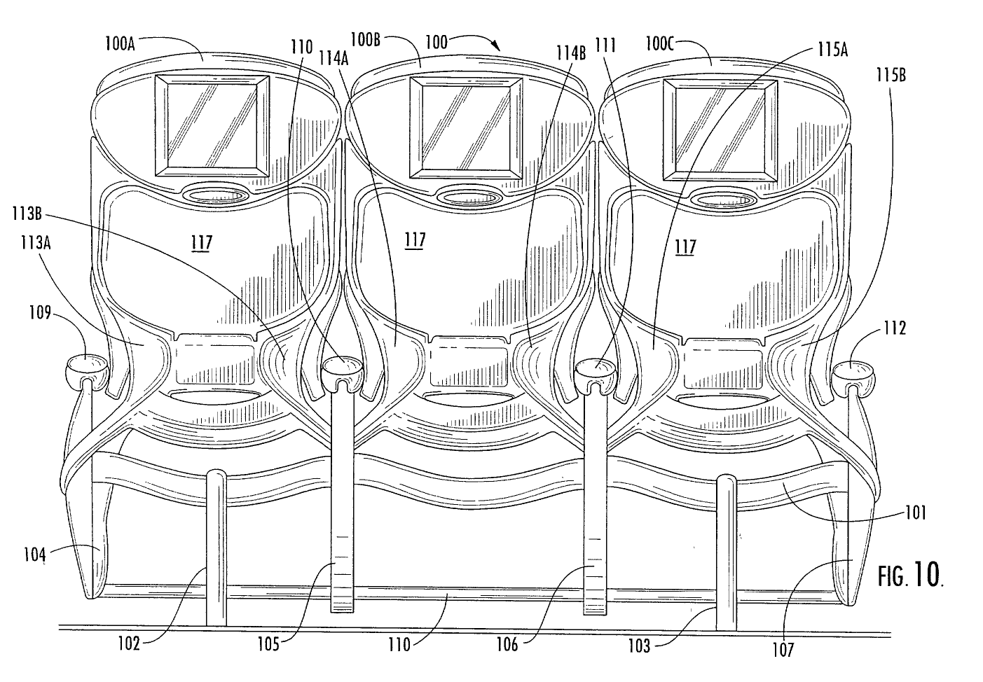

Referring now to FIGS. 9 and 10, two further embodiments of seat sets according to the invention are shown at 80 and 100, respectively.

Seat set 80 includes three seats 80A, 80B, 80C mounted on a single curved tubular beam 81, as described above, carried by two leg assemblies 82, 83. The seats 80A, 80B, 80C are also supported by seat frames 84, 85, 86, 87 that carry a baggage guard rail 88. Forward-pivoted arm rests 89, 90, 91 and 92 are carried by the seat frames 84, 85, 86, 87. Concave, inwardly-dished areas 93A, 93B, 94A, 94B, and 95A, 95B, as described above, in the seat back provide additional knee room to the passenger seated aft of the seats 80A, 80B, 80C. Each of the seats 80A, 80B, 80C have a meal tray 97.

Seat set 100 includes three seats 100A, 10B, 10C mounted on a single curved tubular beam 101, as described above, carried by two leg assemblies 102, 103. The seats 10A, 10B, 100C are also supported by seat frames 104,105, 106, 107 that carry a baggage guard rail 110. Forward-pivoted arm rests 109, 110, 111 and 112 are carried by the seat frames 104, 105, 106, 107. Concave, inwardly-dished areas 113A, 113B, 114A, 114B, and 115A, 115B, as described above, in the seat back provide additional knee room to the passenger seated aft of the seats 100A, 100B, 100C. Each of the seats 100A, 100B, 100C have a meal tray 117.

A passenger seat is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A passenger seat of the type having passenger-controllable functions, comprising:
(a) a seat base, a seat frame mounted on the seat base, and a seat back and seat bottom carried by the seat frame, the passenger seat including at least one passenger-operable function; and
(b) function control communication means carried by the passenger seat for operative communication with a rearward-facing seat back panel of a second passenger seat positioned immediately forward of the passenger seat; and
(c) manual function controls carried on the rearward-facing seat back panel for operative connection with the function control communication means for permitting a passenger seated in the passenger seat to control functions of said seat by manual utilization of the manual function controls on the seat back panel of the second passenger seat immediately forward of the passenger.

2. A passenger seat according to claim 1, wherein the passenger-operable function is chosen from the group consisting of audio/video controls, a seat back position control, a seat bottom position control, a flight attendant call control, reading light control and ventilation control.

3. A passenger seat according to claim 1 or 2, and including a video display mounted in the rear-facing seat back panel of the second passenger seat for viewing by the passenger in the passenger seat.

4. A passenger seat according to claim 1 or 2 and including a meal tray carried by the rear-facing seat back panel of the second passenger seat for movement by the passenger in the passenger seat between an upright stowed position against the seat back panel and a lowered use position over the lap and knees of the passenger.

5. A passenger seat according to claim 1 or 2 and including:
(a) a video display mounted in the rear-facing seat back panel of the second passenger seat for viewing by the passenger in the passenger seat; and
(b) a meal tray carried by the rear-facing seat back panel of the second passenger seat for movement by the passenger in the passenger seat between an upright stowed position against the seat back panel and a lowered use position over the lap and knees of the passenger.

6. A passenger seat according to claim 3, wherein the manual function controls are positioned around the video display monitor.

7. A method of providing a means of controlling seat functions by a passenger, and comprising the steps of:
(a) providing a first passenger seat, including a seat base, a seat frame mounted on the seat base, and a seat back and seat bottom carried by the seat frame, the passenger seat including at least one passenger-operable function;
(b) providing function control communication means on the first passenger seat;
(c) providing manual function controls on a rearward-facing seat back panel of a second seat positioned immediately forward of the first seat for operative connection with the function control communication means for permitting a passenger seated in the first passenger seat to control functions of the first seat by manual utilization of the manual function controls on the seat back panel of the second passenger seat immediately forward of the passenger.

8. A method according to claim 7, wherein the step of providing function control communication means comprises selecting the passenger-operable function from the group consisting of audio/video controls, a seat back position control, a seat bottom position control, a flight attendant call control, reading light control and ventilation control.

9. A method according to claim 7 or 8, and including the step of mounting a video display in the rear-facing seat back panel of the second passenger seat for viewing by the passenger in the first passenger seat.

10. A method according to claim 7 or 8, and including the step of mounting a meal tray on the rear-facing seat back panel of the second passenger seat for movement by the passenger in the first passenger seat between an upright stowed position against the seat back panel and a lowered use position over the lap and knees of the passenger.

11. A method according to claim 7 or 8, and including the steps of:
(a) mounting a video display in the rear-facing seat back panel of the second passenger seat for viewing by the passenger in the first passenger seat; and
(b) mounting a meal tray on the rear-facing seat back panel of the second passenger seat for movement by the passenger in the first passenger seat between an upright stowed position against the seat back panel and a lowered use position over the lap and knees of the passenger.

12. A method according to claim 9, and including the step of positioning the manual function controls are around the video display monitor.

13. A passenger seat of the type having passenger-controllable functions, comprising:
a seat base, a seat frame mounted on the seat base, and a seat back and seat bottom carried by the seat frame, the passenger seat including at least one passenger-operable function; and
(b) passenger-operable function control communication means for operative communication with a control panel positioned on a support immediatelyforward of the passenger seat; and
(c) function controls carried on the control panel for operative connection with the function control communication means for permitting a passenger seated in the passenger seat to control functions of said seat by utilization of the function controls on the control panel.

14. A passenger seat according to claim 13, wherein the control panel is mounted on a rearwardly-facing side of a second forwardly-positioned passenger seat.

15. A passenger seat according to claim 13, wherein the control panel is controlled by a wireless remote controller.

16. A passenger seat according to claim 13, wherein the control panel is controlled by manual controls positioned within reach of a passenger when seated in an aft-positioned seat.
